(19) United States
(12) Patent Application Publication
(10) Pub. No.: US 2022/0038737 A1
(43) Pub. Date: Feb. 3, 2022

(54) METHODS AND APPARATUS FOR FLEXIBLE GRID REGIONS

(71) Applicant: VID SCALE, INC., Wilmington, DE (US)

(72) Inventors: Yong He, San Diego, CA (US); Yan Ye, San Diego, CA (US); Ahmed Hamza, Montreal (CA)

(21) Appl. No.: 17/275,249

(22) PCT Filed: Sep. 13, 2019
(86) PCT No.: PCT/US2019/051000

§ 371 Date: Mar. 11, 2021

Related U.S. Application Data
(60) Provisional application No. 62/731,777, filed on Sep. 14, 2018.

(51) Int. Cl. H04N 19/563; H04N 19/119; H04N 19/174; H04N 19/117

(52) U.S. Cl. CPC H04N 19/563; H04N 19/117; H04N 19/174; H04N 19/119

(57) ABSTRACT

Methods and apparatus for using flexible grid regions in picture or video frames are disclosed. In one embodiment, a method includes receiving a set of first parameters that defines a plurality of first grid regions comprising a frame. For each first grid region, the method includes receiving a set of second parameters that defines a plurality of second grid regions, and the plurality of second grid regions partitions the respective first grid region. The method further includes partitioning the frame into the plurality of first grid regions based on the set of first parameters, and partitioning each first grid region into the plurality of second grid regions based on the respective set of second parameters.

### BACKGROUND

Embodiments disclosed herein generally relate to signaling and processing picture or video information. For example, one or more embodiments disclosed herein are related to methods and apparatus for using flexible grid regions or tiles in picture/video frames.

### BRIEF DESCRIPTION OF THE DRAWINGS

A more detailed understanding may be had from the detailed description below, given by way of example in conjunction with the drawings appended hereto. Figures in the description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is an example of HEVC tile partition having tile columns and rows being evenly distributed across a picture according to one or more embodiments;

FIG. 2B is an example of HEVC tile partition having tile columns and rows are not evenly distributed across a picture according to one or more embodiments;

FIG. 3 is a diagram illustrating an example of repetitive padding scheme that copies sample values from picture boundaries according to one or more embodiments;

FIG. 4 is a diagram illustrating an example of a geometry padding process using an equirectangular projection (ERP) format according to one or more embodiments;

FIG. 5 is a diagram illustrating an example of merging of HEVC MCTS-based region tracks of a same resolution according to one or more embodiments;

FIG. 6 is a diagram illustrating an example of cubemap (CMP) partitioning according to one or more embodiments;

FIG. 7 is a diagram illustrating an example of CMP partitioning with slice headers according to one or more embodiments;

FIG. 8 is a diagram illustrating an example of a pre-processing and encoding scheme for achieving 6K effective ERP resolution (HEVC-based) according to one or more embodiments;

FIG. 9A is a diagram illustrating a partitioning example using conventional tiles, according to one or more embodiments;

FIG. 9B is a diagram illustrating a partitioning example using flexible tiles, according to one or more embodiments;

FIG. 10 is a diagram illustrating an example of geometry padding for flexible tile according to one or more embodiments;

FIG. 11A is a diagram illustrating a first example of region-based flexible tile signaling according to one or more embodiments;

FIG. 11B is a diagram illustrating a second example of region-based flexible tile signaling according to one or more embodiments;

FIG. 12A is a diagram illustrating an example of a coding tree block (CTB) raster scan of a picture according to one or more embodiments;

FIG. 12B is a diagram illustrating an example of a CTB raster scan of conventional tiles according to one or more embodiments;

FIG. 12C is a diagram illustrating an example of a CTB raster scan of region-based flexible tiles according to one or more embodiments; and

FIG. 13 is a diagram illustrating an example of using a respective tile identifier for each region-based tile according to one or more embodiments.

### DETAILED DESCRIPTION

### I. Exemplary Networks and Devices

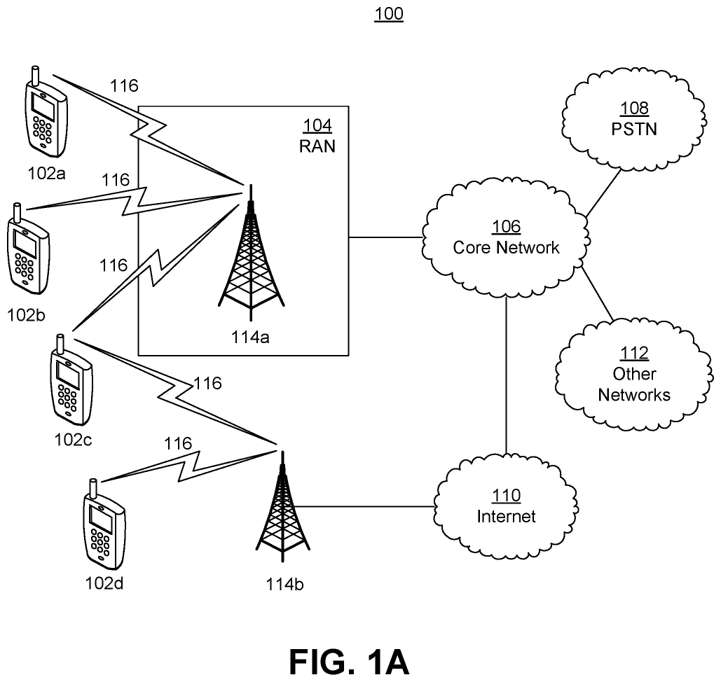

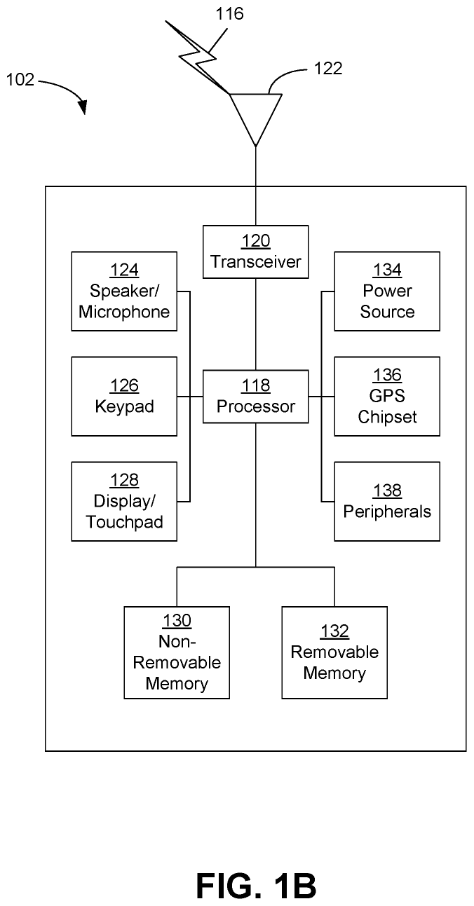

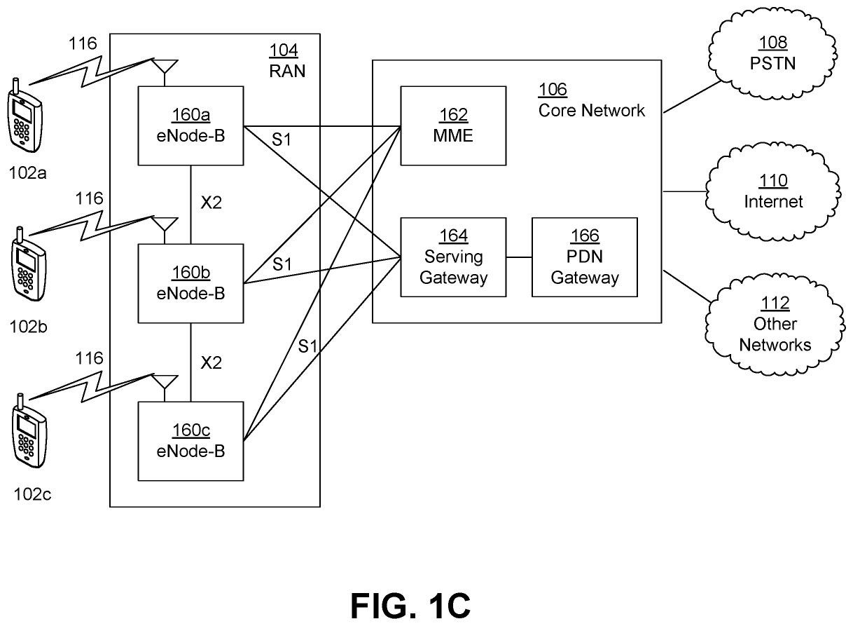

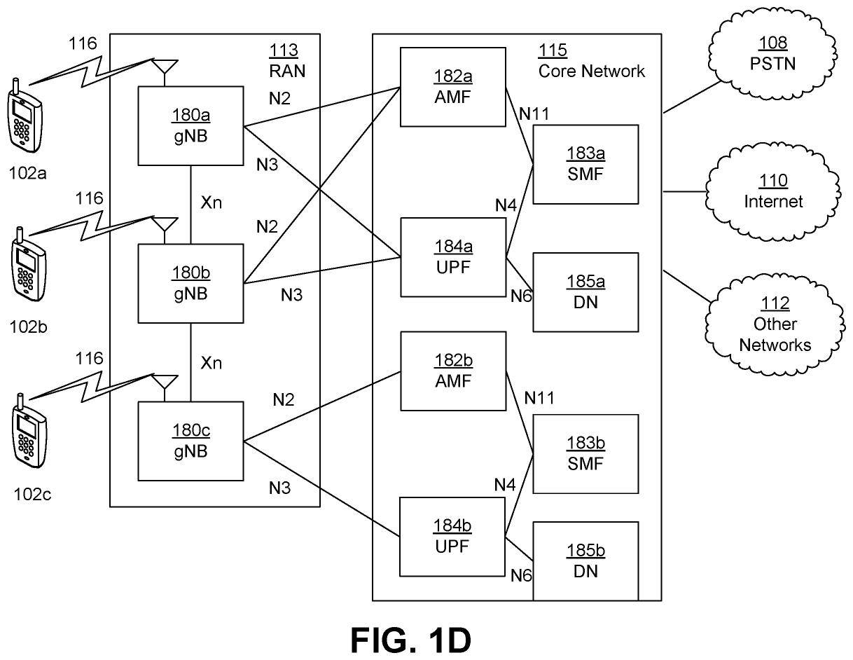

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a New Radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, a Home Node B, a Home eNode B, or an access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In some representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating a WTRU or UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Video coding systems may be used to compress digital video signals, which may reduce the storage needs and/or the transmission bandwidth of video signals over a network such as any of the networks described above. Video coding systems may include block-based, wavelet-based, and/or object-based systems. Block-based video coding systems may be based on, use, be in accordance with, comply with, etc. one or more standards, such as MPEG-1/2/4 part 2, H.264/MPEG-4 part 10 AVC, VC-1, High Efficiency Video Coding (HEVC), and/or Versatile Video Coding (WC). Block-based video coding systems may include a block-based hybrid video coding framework.

In some examples, a video streaming device may comprise one or more video encoders, and each encoder may generate a video bitstream at a different resolution, frame rate, or bitrate. A video streaming device may comprise one or more video decoders, and each decoder may detect and/or decode an encoded video bitstream. In various embodiments, the one or more video encoders and/or one or more decoders may be implemented in a device having a processor communicatively coupled with memory, a receiver, and/or a transmitter. The memory may include instructions executable by the processor, including instructions for carrying out any of various embodiments (e.g., representative procedures) disclosed herein. In various embodiments, the device may be configured as and/or configured with various elements of a wireless transmit and receive unit (WTRU). Example details of WTRUs and elements thereof are provided herein in FIGS. 1A-1D and accompanying disclosure.

### II. HEVC

II.1 High Efficiency Video Coding (HEVC) Tile

In some examples, a video frame may be divided into slices and/or tiles. A slice is a sequence of one or more slice segments starting with an independent slice segment and containing all subsequent dependent slice segments. A tile is rectangular and contains an integer number of coding tree units as HEVC specifies. One or both of the following conditions shall be fulfilled for each slice and tile (e.g., See [1]): 1) all coding tree units in a slice belong to the same tile; and/or 2) all coding tree units in a tile belong to the same slice.

In some examples, the tile structure in HEVC is signaled in a picture parameter set (PPS) by specifying the heights of rows and the widths of columns. Individual row(s) and/or column(s) may have different size(s), but the partitioning may always span across the entire picture, from left to right or from top to bottom.

In some examples, an HEVC tile syntax may be used. In an example, as shown in Table 1, a first flag, tiles_enabled_flag, may be used to specify whether tiles are used or not. For example, if the first flag (tiles_enabled_flag) is set, the number of tiles columns and rows are specified. A second flag, uniform_spacing_flag, may be used to specify whether the tile column boundaries and likewise tile row boundaries are distributed uniformly across the picture or not. For example, when uniform_spacing_flag is equal to zero (0), the syntax elements column_width_minus1[i] and row_height_minus1[i] are explicitly signaled to specify the width of column and the height of row. In addition, a third flag, loop_filter_across_tiles_enabled_flag, may be used to specify whether in-loop filters across tile boundaries are turned on or off for all tile boundaries in the picture.

TABLE 1
HEVC Tile syntax

Descriptor

pic_parameter_set_rbsp( ) {

| | |
|---|---|
| ... | |
| tiles_enabled_flag | u(1) |
| ... | |
| if( tiles_enabled_flag ) { | |

| | |
|---|---|
| num_tile_columns_minus1 | ue(v) |
| num_tile_rows_minus1 | ue(v) |
| uniform_spacing_flag | u(1) |
| if( !uniform_spacing_flag ) { | |

for( i = 0; i < num_tile_columns_minus1; i++ )

| | |
|---|---|
| column_width_minus1[i] | ue(v) |

for( i = 0; i < num_tile_rows_minus1; i++ )

| | |
|---|---|
| row_height_minus1[i] | ue(v) |

| | |
|---|---|
| } | |
| loop_filter_across_tiles_enabled_flag | u(1) |

}
...

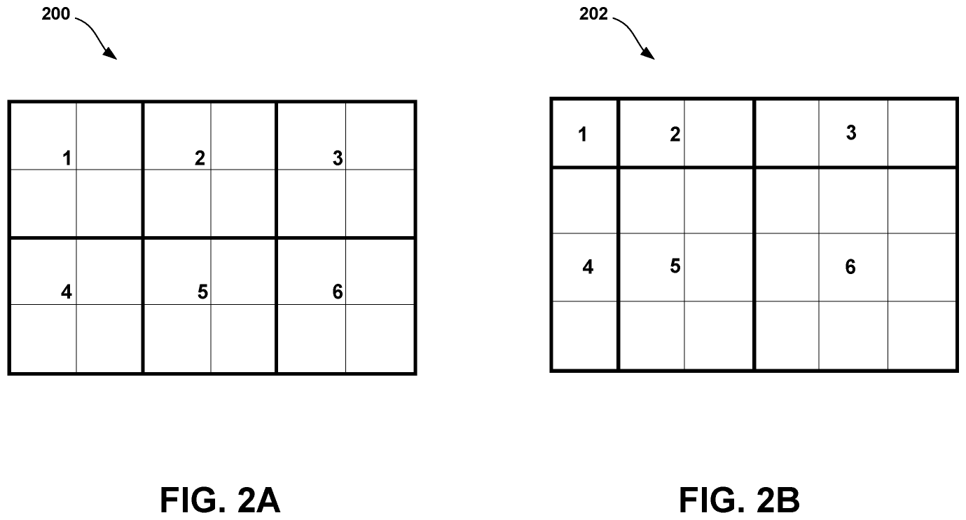

In one implementation, two examples of tile partition are shown in FIG. 2A and FIG. 2B. In the first example, tile column(s) and row(s) are evenly distributed (in six grid regions) across a picture 200 as shown in FIG. 2A. In the second example, tile column(s) and row(s) are not evenly distributed (in six grid regions) across a picture 202 as shown in FIG. 2B, and therefore, the tile column width and row height may need to be explicitly specified.

In some examples, HEVC specifies a special tile set called a temporal motion-constrained tile set (MCTS) via a Supplemental Enhancement Information (SEI) message. An MCTS SEI message indicates that the inter prediction process is constrained such that no sample value outside each identified tile set, and/or no sample value at a fractional sample position that is derived using one or more sample values outside the identified tile set, may be used for inter-prediction of any sample within the identified tile set [1]. In some cases, each MCTS may be extracted from an HEVC bitstream and decoded independently.

II.2 Padding for Motion Compensated Prediction

In some examples, existing video codecs are designed for conventional two-dimensional (2D) video captured on a plane. When motion compensated prediction uses any samples outside of a reference picture's boundaries, repetitive padding is performed by copying the sample values from the picture boundaries.

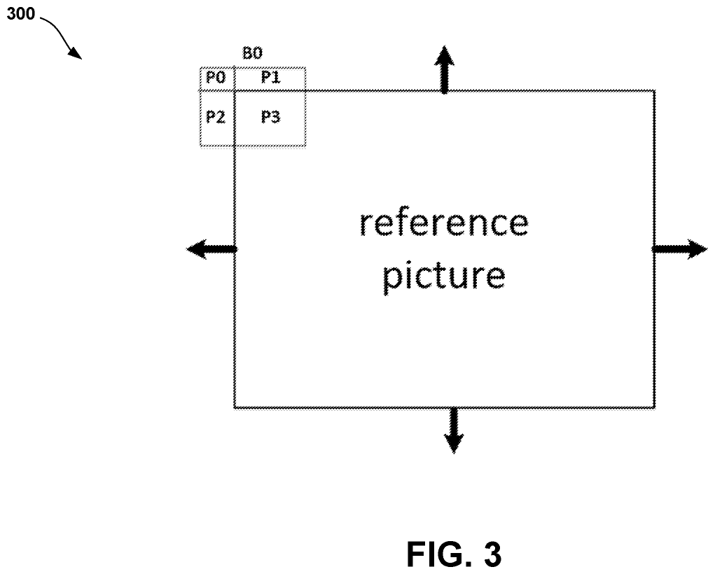

In an example, FIG. 3 illustrates a repetitive padding scheme 300. For example, a block B0 is partially outside of the reference picture. A part P0 is filled with the top-left sample of a part P3. A part P1 is filled line by line with the top line of the part P3. A part P2 is filled column by column with the left column of the part P3.

In some examples, a 360-degree video encompasses video information on a whole sphere, and therefore the 360-degree video intrinsically has a cyclic property. When considering this cyclic property, the reference pictures of the 360-degree video no longer have “boundaries”, as the information contained in the “boundaries” is all wrapped around a sphere. In some implementations, geometry padding for a 360-degree video may be used (e.g., geometry padding proposed in JVET-D0075 [5]).

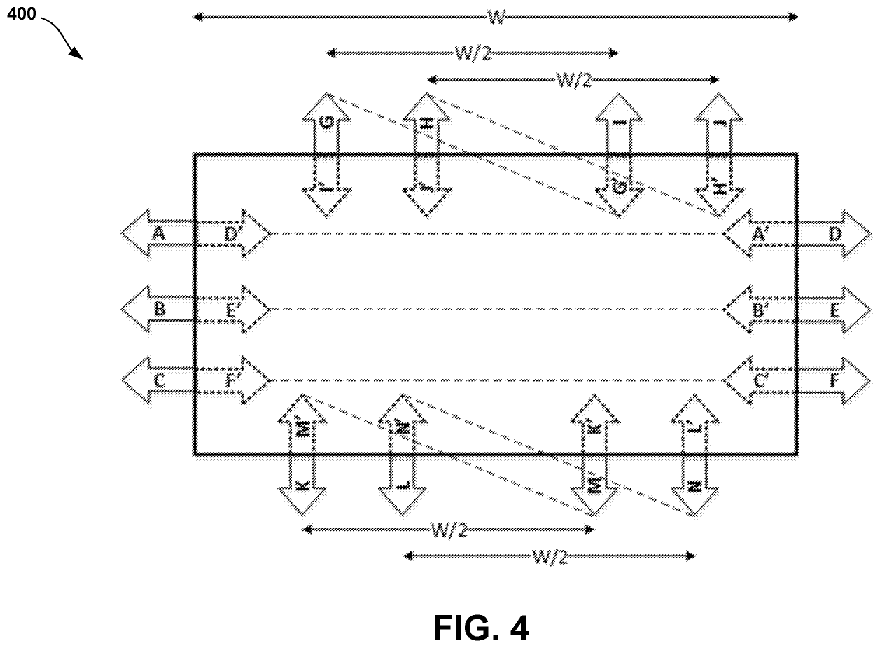

In an example, FIG. 4 illustrates a geometry padding process 400 for a 360-degree video having an equirectangular projection format (ERP). In this example, the geometry padding process for ERP may include: a padding to be filled in at an arrow (e.g., arrow A) that is taken along a corresponding arrow (e.g., arrow A′), and so forth, and the alphabetic labels show the correspondence. For example, in the left boundary and right boundary of the 360-degree video, the samples at A, B, C, D, E and F are padded with the sample at A′, B′, C′, D′, E′ and F′. In the top boundary, the samples at G, H, I and J are padded with the sample at G′, H′, I′ and J′. In the bottom boundary, the samples at K, L, M and N are padded with the sample at K′, L′, M′ and N′. Compared to the repetitive padding method currently used in HEVC, the geometry padding can provide meaningful samples and improve continuity of neighboring samples for areas outside of the ERP picture boundaries.

### III. Viewport Dependent Omnidirectional Video Processing

Omnidirectional Media Format (OMAF) is a system standard format developed by Moving Picture Experts Group (MPEG). OMAF defines a media format that enables omnidirectional media including 360-degree video, image, audio and associated timed text. Several viewport-dependent omnidirectional video processing schemes are described in, for example, Annex D of OMAF specification [2].

In an example, an equal-resolution MCTS-based viewport-dependent scheme encodes the same omnidirectional video content into several HEVC bitstreams at different picture qualities and bitrates. Each MCTS is included in one region track and an extractor track is also created. An OMAF player chooses the quality at which each sub-picture track is received based on the viewing orientation.

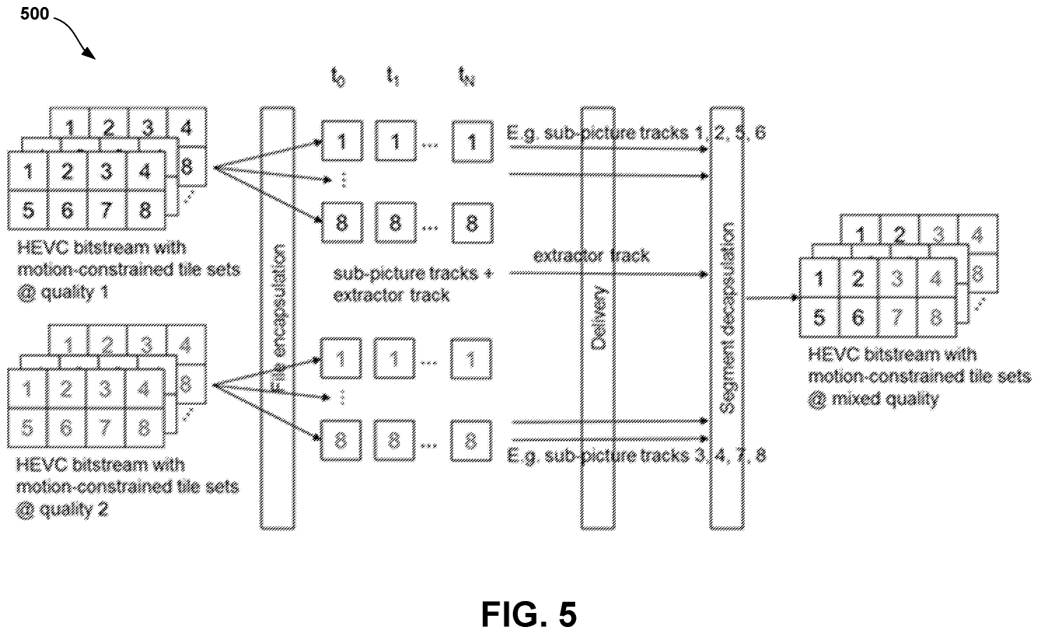

FIG. 5 illustrates an example scheme 500 from clause D4.2 of OMAF [2]. In this example, the OMAF player receives MCTS tracks 1, 2, 5, and 6 at a particular quality and region tracks 3, 4, 7, and 8 at another quality. The extractor track is used to reconstruct a bitstream that may be decoded with a single HEVC decoder. The tiles of the reconstructed HEVC bitstream with MCTS at different quality may be signaled by an HEVC tile syntax discussed herein.

In another example, an MCTS-based viewport-dependent video processing scheme is used to encode the same omnidirectional video source content(s) into several spatial resolutions. Based on the viewing orientation, an extractor may select those tiles matching the viewing orientation in high resolution and other tiles in low resolution. The bitstream resolved from the extractor tracks conforms to HEVC and may be decoded by a single HEVC decoder.

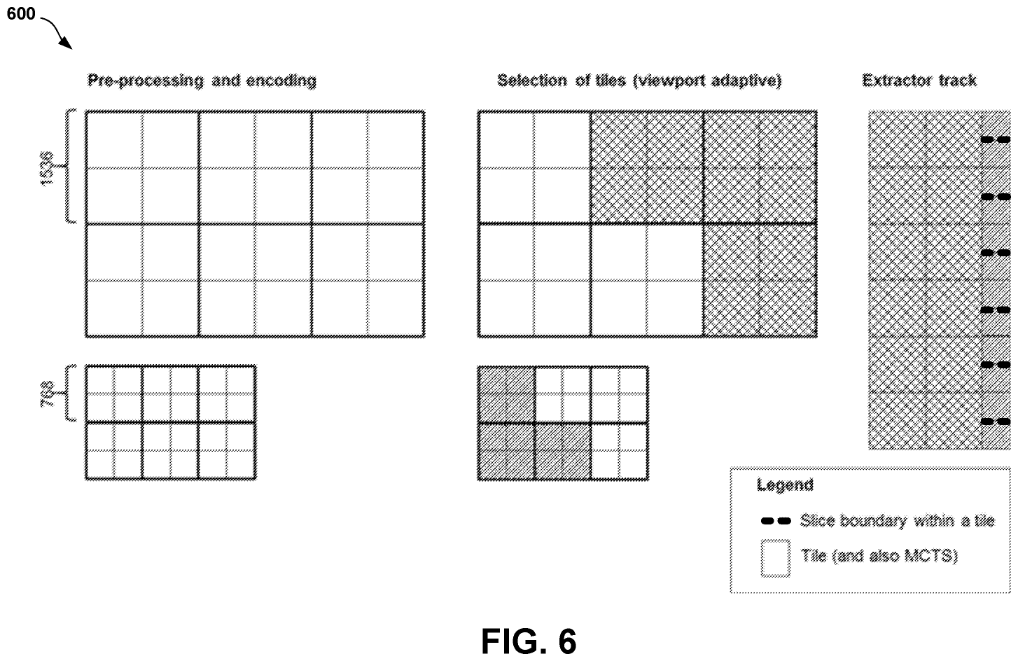

FIG. 6 illustrates an example of a Cubemap (CMP) partitioning scheme 600 from clauses D.6.4 of OMAF [2]. In this example, pre-processing and encoding is shown for achieving a 6K effective CMP resolution with an HEVC-based viewport-dependent OMAF video profile. The content is encoded at two spatial resolutions having CMP face sizes 1536×1536 and 768×768, respectively. In both bitstreams, a 6×4 tile grid is used, and an MCTS is coded for each tile position. Each coded MCTS sequence is stored as a region track. An extractor track is created for each distinct viewport-adaptive MCTS selection. This results in 24 extractor tracks being created. In each sample of the extractor track, one extractor is created for each MCTS, extracting data from the region track that contains one or more selected high-resolution or low-resolution MCTSs. Each extractor track uses the same tile grid of 3×6 tiles having tile column widths equal to 768, 768, and/or 384 luma samples (e.g., one or more pixels of luminance), and/or a constant tile row height of 768 luma samples. Each tile extracted from the low-resolution bitstream contains two slices. The bitstreams resolved from the extractor tracks have a resolution of 1920×4608, which conforms to, for example, HEVC Level 5.1.

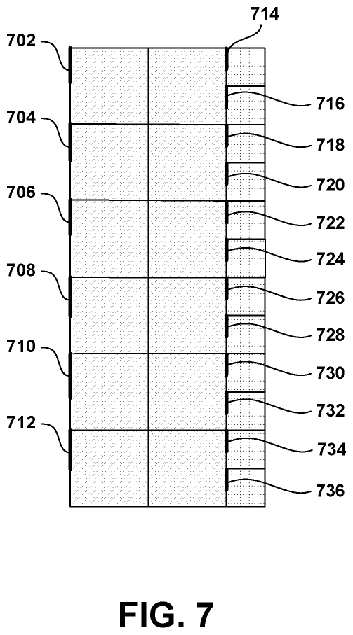

In some cases, the MCTSs of the above reconstructed bitstream(s) may not be represented using the HEVC tile syntax discussed above (e.g., in Table 1). Instead, slice may be used for each partition. Referring to FIG. 7, in an example, there are two extracted tracks, a left extracted track and a right extracted track. The left extracted track has 6 slice headers, which are represented as slice headers 702, 704, 706, 708, 710, and 712. The right extracted track has 12 slice headers, which are represented as slice headers 714, 716, 718, 720, 722, 724, 726, 728, 730, 732, 734, and 736. In this case, the partitioning of extractor track(s) in FIG. 6 may end up with 12 slice headers as shown in FIG. 7.

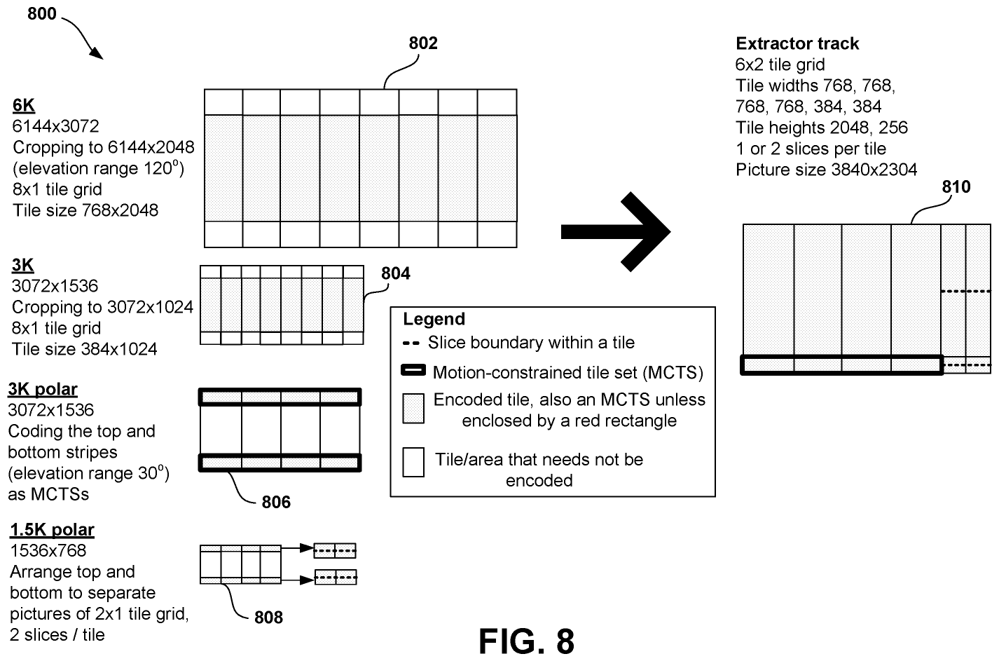

FIG. 8 illustrates an example of a pre-processing and encoding scheme 800 for achieving a 6K effective ERP resolution (e.g., HEVC-based). OMAF clause D6.3 presents a MCTS-based viewport-dependent scheme for achieving a 6K effective ERP resolution. In an example, an omnidirectional video of 6K resolution (6144×3072) is resampled to 3 spatial resolutions, namely 6K (6144×3072), 3K (3072×1536), and 1.5K (1536×768). The 6K and 3K sequences are cropped to 6144×2048 (as shown in grid 802) and 3072×1024 (as shown in grid 804), respectively, by excluding 30-degree elevation range from the top and the bottom. The cropped 6K and 3K input sequences are encoded with an 8×1 tile grid in a manner that each tile is an MCTS.

As shown in grid 806, the top and bottom stripes of size 3072×256 corresponding to 30-degree elevation range are extracted from the 3K input sequence. The top stripe and the bottom stripe are encoded as separate bitstreams with a 4×1 tile grid in a manner that the row of tiles is a single MCTS. As shown in grid 808, the top and bottom stripes of size 1536×128 corresponding to 30-degree elevation range are extracted from the 1.5K input sequence. Each stripe is arranged into a picture of size 768×256, for example, by arranging the left side of the stripe on the top of the picture and the right side of the stripe at the bottom of the picture.

In this example, each MCTS sequence from the cropped 6K and 3K bitstreams may be encapsulated as a separate track. Each bitstream containing a top or bottom stripe of the 3K or 1.5K input sequence may be encapsulated as one track (e.g., track 810).

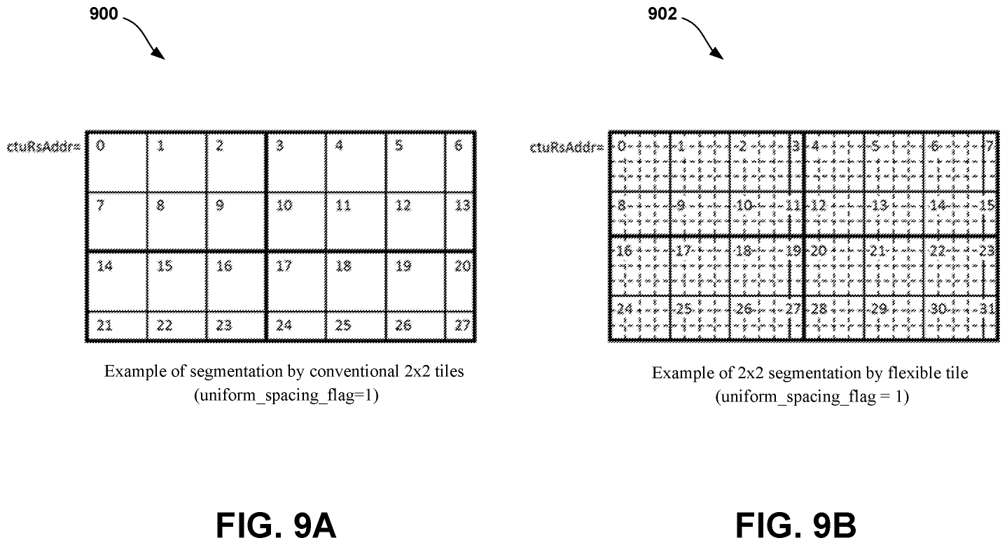

An extractor track is prepared for each selection of four adjacent tiles from the cropped 6K bitstream and separately for viewing orientations above and below the equator. This results in 16 extractor tracks being created. Each extractor track uses a same arrangement, for example, as illustrated in FIG. 9A and FIG. 9B. For example, in FIG. 9A, a grid 900 includes segmentation by conventional 2×2 tiles (uniform_spacing_flag=1). In FIG. 9B, a grid 902 includes segmentation by flexible tiles (uniform_spacing_flag=1). The picture size of the bitstream resolved from the extractor track is 3840×2304, which conforms to HEVC Level 5.1. In some cases, the tile partitioning of the extractor track may not be specified with the HEVC tile syntax discussed above (e.g., in Table 1).

### IV. HEVC Tiles

The tiles in HEVC align with coding tree unit (CTU) boundaries. In some examples, the main use for HEVC tiles is to partition pictures into independent segments with minimal compression efficiency losses. In one implementation, HEVC tiles are used to partition pictures for viewport dependent omnidirectional video processing. The source video is then partitioned and encoded using one or more MCTSs that may be decoded independently of neighboring tile sets. The extractor may select a subset of the tile sets based on a viewport direction and form a HEVC compliant extractor track for the OMAF player consumption.

For next generation video compression standard(s), such as Versatile Video Coding (VVC), the size of the CTU may become larger due to increases in the resolution of images. The granularity of tile segmentation also may become too large to align with frame packing boundaries. It also would be difficult to split a picture into equal size CTUs for load balancing. Furthermore, the conventional tile structure may not handle the aforementioned partition structure for OMAF viewport-dependent processing, while the bit cost by using slices for the partition is high.

A flexible tile structure and syntax was proposed by JVET-K0155 [3] and JVET-K0260 [4] in MPEG #123. JVET-K0155 proposed that pictures may be split into constant size CTUs as the conventional tile while the size of the right-most and bottommost CTUs in tile boundary can be different from the constant CTU size to achieve better load balancing and align with frame packing boundary. The CTUs of odd size in the right and bottom edge of each tile are encoded and decoded as same as in picture boundary.

JVET-K0260 proposed to support flexible tile with rectangular shape but with varying sizes. Each tile would be signaled individually, either by copying the tile size from the previous tile size in decoding order or by one tile width and one tile height code word. With the proposed syntax, the partitioning structure shown in FIG. 6 and FIG. 8 may be supported. However, such syntax format may result in significant overhead cost for commonly used conventional tile structure comparing to the HEVC tile syntax format.

Therefore, new or improved methods, schemes, and signal designs are desired to support flexible tile (e.g., in video frames).

### V. Representative Procedure for Flexible Tiles

In this disclosure, we describe a number of embodiments, procedures, methods, architectures, tables, and signal designs to support flexible grid region or tile, including, for example: 1) constraint of the geometry padding and loop filter for flexible tile; 2) signaling to differentiate conventional tile and flexible tile to reduce the overall signaling overhead; 3) grid region-based flexible tile signaling design and scanning conversion; and 4) initial quantization parameter (QP) signaling for tile-based video processing.

In various embodiments, the term “regions” used in this disclosure may represent a first set of grid regions, and the term “tiles” used in this disclosure may represent a second set of grid regions. In an example, a picture or video frame may be divided into a first set of grid regions (e.g., regions), and each grid region of the first set of grid regions can be further divided into a second set of grid regions (e.g., tiles). In some cases, the terms “regions,” “grid regions,” and “tiles” used in this disclosure may be exchangeable, and may be represented as the first set or the second set of grid regions.

V.1 Padding and Loop Filter Constraint on a Tile Boundary

The conventional tile partitioning may not have integer multiples of CTUs at the right edge or bottom edge of the picture, and flexible tile may not have integer multiple of CTUs at right edge or bottom edge of the tile. FIG. 9, in an example, illustrates such incompletion for both conventional tile and flexible tile cases using conventional methods. The incomplete CTUs along the right and bottom edge of each tile may be encoded and decoded the same as in a picture boundary.

The geometry padding assumes the information that a 360-degree video contains is all wrapped around a sphere, and such cyclic property holds regardless of which projection format is used to represent the 360-degree video on a 2D plane. Geometry padding may apply to a 360-degree video picture boundary, but may not apply to the flexible tile boundary since the cyclic property relies on the partitioning structure. Based on the tile partitioning, the encoder may determine or decide whether the horizontal geometry padding or vertical geometry padding may be deployed for the motion compensated prediction for example, for each tile.

In some embodiments, a padding flag may be signaled (e.g., to a receiver of a WTRU) to indicate whether padding operations may be performed on tile edge(s). If the padding_enabled_flag is set, the repetitive padding or geometry padding may be performed on the tile edge(s). In some examples, for flexible tile syntax structure, each tile may be signaled individually. In some cases, a geometry_padding_indicator and a repetitive_padding_indicator may be signaled for each tile.

In some embodiments, a loop_filter_across_tiles_enabled_flag was signaled in HEVC to indicate whether loop filter operations may be performed across the tile boundaries in PPS. If the loop_filter_across_tile_enabled_flag is set, for instance, a loop_filter_indicator may be signaled to indicate which edge of the tile may be filtered.

In an example, Table 2 illustrates a padding and loop filter syntax format for tile(s) or grid region(s).

TABLE 2
Padding and Loop Filter Syntax

Descriptor

geometry_padding_format( ) {

| | |
|---|---|
| padding_enabled_flag | u(1) |
| if (padding_enabled_flag) { | |

| | |
|---|---|
| geometry_padding_indicator | u(4) |
| repetitive_padding_indicator | u(4) |

}
if (loop_filter_across_tiles_enabled_flag)

| | |
|---|---|
| loop_filter_indicator | u(4) |

}

In Table 2, padding_enable_flag equal to 1 indicates that padding operations may be used in the current tile, padding_enable_flag equal to 0 indicates that padding operations are not used in the current tile.

In Table 2, geometry_padding_indicator is a bitmap mapping each tile edge to a bit. One example of bit mapping could be the most significant bit is a flag for the top edge, and the second most significant bit is a flag for the right edge and so on in clockwise order. When the bit value equal to 1, geometry padding operations may apply to the corresponding tile edge; when the bit value equal to 0, geometry padding operations are not performed to the corresponding tile edge. When not present, the default value of geometry_padding_indicator can be inferred to be equal to 0.

In Table 2, repetitive_padding_indicator is a bitmap mapping each tile edge to a bit. One example of bit mapping could be the most significant bit is a flag for the top edge, and the second most significant bit is a flag for the right edge and so on in clockwise order. When the bit value equals 1, repetitive padding operations applies to the corresponding tile edge; when the bit value equals 0, repetitive padding operations are not performed to the corresponding tile edge. When not present, the default value of repetitive_padding_indicator can be inferred to be equal to 0.

In Table 2, loop_filter_indicator is a bitmap mapping each tile edge to a bit. When the bit value equals 1, loop filter operations may be performed across the corresponding tile edge; when the bit value equals 0, loop filter operations are not performed across the corresponding tile edge. When not present, the default value of loop_filter_indicator may be inferred to be equal to 0.

In another embodiment, a padding enabled flag, padding_on_tile_enabled_flag, may be signaled at the PPS level. When padding_on_tile_enabled_flag equals 0, the padding_enabled_flag at tile level is inferred to be 0.

In another embodiment, the geometry padding may be disabled when the size of the current tile edge and the size of corresponding reference boundary are not the same (e.g., being different).

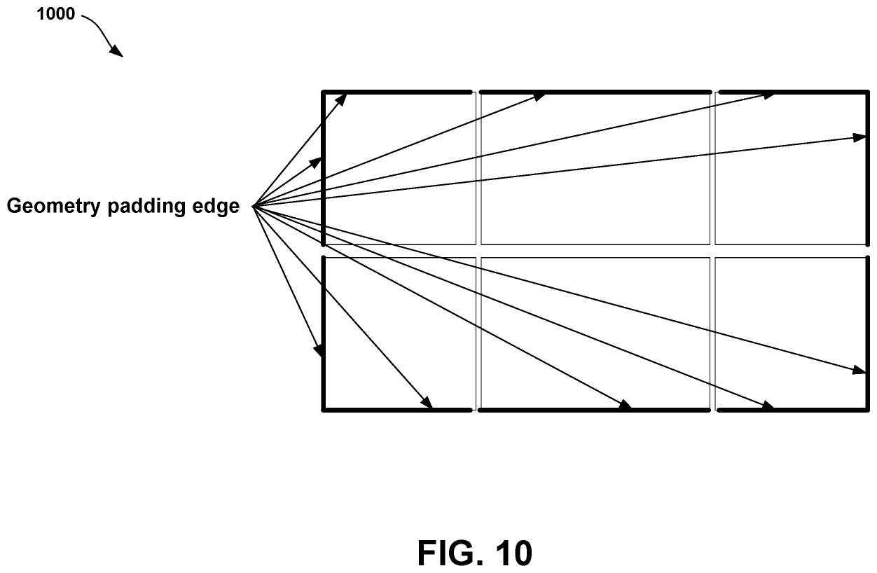

FIG. 10 illustrates an example of using flexible tile in an ERP picture. In this example, an ERP picture 1000 may be divided into a number of tiles each with varying size. Geometry padding may be enabled for a particular tile edge depending on the tile partitioning grid.

V.2 Signaling to Differentiate Conventional and Flexible Tile Grid

Conventional tile partitioning restricts all tiles belonging to the same tile row to have the same row height, and all tiles belonging to the same tile column to have the same column width. Such restriction simplifies the tile signaling and ensures the tile set is rectangular in shape. Flexible tile allows individual tiles to have different sizes and allows the properties of each tile to be signaled individually. Such signaling supports various partitioning grids, but may introduce significant bit overhead. A compromise between the overhead bit cost and tile partitioning flexibility may be realized by including an indicator or flag to differentiate between a conventional partitioning grid and a flexible partitioning grid. The indicator or flag may indicate whether the entire picture is partitioned into regular M×N grid or not, where M and N are the integers. The conventional HEVC tile syntax may apply to regular M×N tile grid, while a new flexible tile syntax, such as discussed in JVET-K0260 or in this disclosure, may apply to flexible tile grid.

In some examples, the indicator or flag discussed herein may be signaled at or in a sequence parameter set and/or a picture parameter set.

V.3 Grid Region Based Signaling for Flexible Tiles

In some examples, the tile column boundaries and, likewise, tile row boundaries span across the picture. The use cases that motivate flexible tile are viewport-dependent omnidirectional video processing approaches where multiple MCTS tracks from different picture resolutions are merged into a single HEVC-compliant extractor track. The tile grids of the extractor track may be from different picture resolutions, and therefore the tile column and row boundaries may not be continuous across the picture as shown in FIG. 6 and/or FIG. 8.

Instead of signaling the size of each tile individually, a signaling scheme/design may be used or configured to signal each grid region where a particular tile or region partitioning scheme is employed in that grid region. In an example, different regions may have different grid partitioning to enable flexible tile(s). In this example, a respective region may have a number of tiles, and each tile may have a same or a different size. In some examples, a first tile may have a different size compared with a second tile within a same grid region. In some cases, the tile(s) of each row may share the same height, and the tile(s) of each column may share the same width.

Table 3 shows an exemplary Flexible Tile syntax (e.g., a multi-level syntax) for use in this exemplary signaling scheme/design.

TABLE 3
Flexible Tile Syntax

Descriptor

pic_parameter_set_rbsp( ) {

| | |
|---|---|
| ... | |
| tiles_enabled_flag | u(1) |
| ... | |
| if( tiles_enabled_flag ) { | |

| | |
|---|---|
| num_region_columns_minus1 | ue(v) |
| num_region_rows_minus1 | ue(v) |
| if (NumRegions > 1) { | |

| | |
|---|---|
| uniform_region_flag | u(1) |
| if( !region_uniform_spacing_flag ) { | |

| | |
|---|---|
| region_size_unit_idc | ue(v) |
| for( i = 0; i < num_region_columns_minus 1; i++ ) | |

| | |
|---|---|
| region_column_width_minus1[i] | ue(v) |

for( i = 0; i < num_region_rows_minus1; i++)

| | |
|---|---|
| region_row_height_minus1[i] | ue(v) |

}

}
for (i = 0; i < NumRegions; i++) {

| | |
|---|---|
| num_tile_columns_minus1[i] | ue(v) |
| num_tile_rows_minus1[i] | ue(v) |
| uniform_spacing_flag[i] | u(1) |
| if( !uniform_spacing_flag[i] ) { | |

for( j = 0; j < num_tile_columns_minus1[i]; j++ )

| | |
|---|---|
| column_width_minus1[i][j] | ue(v) |

for( j = 0; j < num_tile_rows_minus1[i]; j++ )

| | |
|---|---|
| row_height_minus1[i][j] | ue(v) |

}

}

| | |
|---|---|
| } | |
| loop_filter_across_tiles_enabled_flag | u(1) |
| ... | |

num_region_columns_minus1 plus 1 specifies the number of region columns partitioning the picture. num_region_columns_minus1 shall be in the range of 0 to PicWidthInCtbsY−1, inclusive.

num_region_rows_minus1 plus 1 specifies the number of region rows partitioning the picture. num_region_columns_minus1 shall be in the range of 0 to PicHeightInCtbsY−1, inclusive.

The region may be in raster scanning order from left to right and from top to bottom. The total number of regions, NumRegions, can be derived as follows:

NumRegions=(num_region_columns_minus1+1)*(num_region_rows_minus1+1)

uniform_region_flag equal to 1 specifies that region column boundaries and, likewise, region row boundaries are distributed uniformly across the picture. The flag, uniform_spacing_flag, being equal to 0 specifies that region column boundaries and, likewise, region row boundaries are not distributed uniformly across the picture but signalled explicitly using the syntax elements region_column_width_minus1 and region_row_height_minus1. When not present, the value of uniform_region_flag is inferred to be equal to 1.

region_size_unit_idc specifies that the unit size of regions is in units of coding tree blocks. When not present, the default value of region_size_unit_idc is inferred to be equal to 0. The variable RegionUnitInCtbsY is derived as follows:

RegionUnitInCtbsY=1<<region_unit_size_idc

region_column_width_minus1 [i] plus 1 specifies the width of the i-th region column in units of coding tree blocks. When not present, the value of region_column_width_minus1 is inferred to be equal to the picture width, PicWidthInCtbsY.

region_row_height_minus1 [i] plus 1 specifies the height of the i-th region row in units of coding tree blocks. When not present, the value of region_row_width_minus1 is inferred to be equal to the picture height, PicHeightInCtbsY.

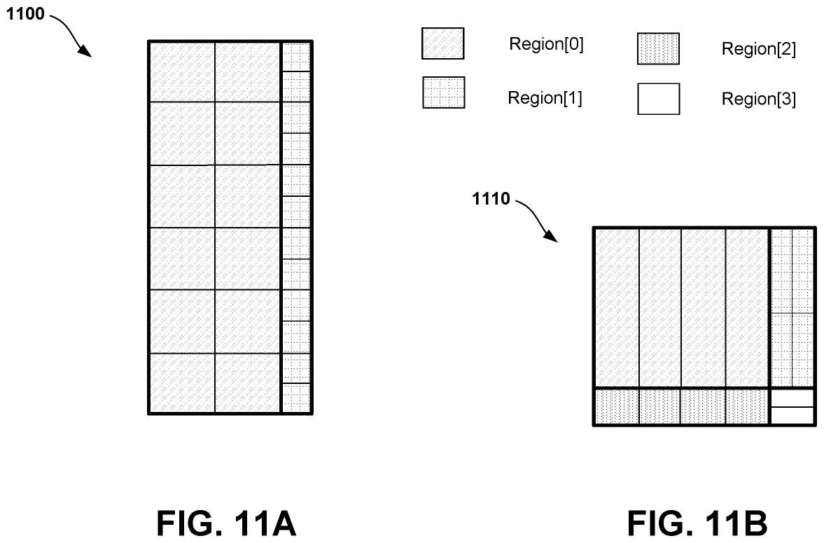

FIG. 11A and FIG. 11B illustrate two examples of region-based flexible tile signaling applied to the extractor tracks shown in FIG. 6 and FIG. 8, respectively.

Referring to FIG. 11A, the extractor track of FIG. 6 is reconstructed as track 1100 from two pictures with different resolutions. Two regions are identified where the tiles are distributed uniformly within each region. The left region of track 1100 is partitioned into a 2×6 grid, and the right region of track 1100 is partitioned into a 1×12 grid.

Referring to FIG. 11B, the extractor track of FIG. 8 is reconstructed as track 1110 from 4 different resolution pictures, and 4 regions are identified where the tiles are distributed uniformly within each region. The first region partitioning grid is 4×1, the second region partitioning grid is 2×2, the third region partitioning grid is 4×1, and the fourth region petitioning grid is 1×2.

In various embodiments, when processing video information (e.g., encoding or decoding videos or pictures), a region partitioning and grouping mechanism discussed herein may be employed. In an example, a WTRU (e.g., WTRU 102) may be configured to receive (or identify) a set of first parameters that defines a plurality of first grid regions (e.g., tiles) comprising a frame (e.g., a video frame or a picture frame). For each first grid region, the WTRU may be configured to receive (or identify) a set of second parameters that defines a plurality of second grid regions, and the plurality of second grid regions may partition a respective first grid region. The WTRU may be configured to partition the frame into the plurality of first grid regions based on the set of first parameters, and partition each first grid region into the plurality of second grid regions based on the respective set of second parameters.

In another example, the WTRU may be configured to receive (or identify) multiple sets of parameters or configurations for processing video information. For example, the WTRU may be configured to receive (or identify) a set of first parameters (that defines a plurality of first grid regions) and a set of second parameters (that defines a plurality of second grid regions). The WTRU may be configured to partition a frame into the plurality of first grid regions based on the set of first parameters, and group (or reconstruct) the plurality of first grid regions into the plurality of second grid regions based on the set(s) of second parameters. In some cases, the first grid regions or second grid regions may be tiles or slices, and may be used to comprise or reconstruct a frame (e.g., a video frame or a picture frame) or generate one or more bitstreams.

V.4 Coding Tree Block (CTB) Raster and Flexible Tile Scanning Conversion Process

In some embodiments, one or more of the following variables may be derived by invoking the coding tree block raster and flexible tile scanning conversion process:
a) The list CtbAddrRsToTs[ctbAddrRs] for ctbAddrRs ranging from 0 to PicSizeInCtbsY−1, inclusive, specifying the conversion from a CTB address in CTB raster scan of a picture to a CTB address in a tile scan;
b) The list CtbAddrTsToRs[ctbAddrTs] for ctbAddrTs ranging from 0 to PicSizeInCtbsY−1, inclusive, specifying the conversion from a CTB address in tile scan to a CTB address in CTB raster scan of a picture;
c) The list TileId[ctbAddrTs] for ctbAddrTs ranging from 0 to PicSizeInCtbsY−1, inclusive, specifying the conversion from a CTB address in tile scan to a tile ID;
d) The list ColumnWidthInLumaSamples[i][j] for j ranging from 0 to num_tile_columns_minus1 [i], inclusive, specifying the width of the j-th tile column of i-th region in units of luma samples; and/or
e) The list RowHeightInLumaSamples[i][j] for j ranging from 0 to num_tile_rows_minus1 [i], inclusive, specifying the height of the j-th tile row of i-th region in units of luma samples.

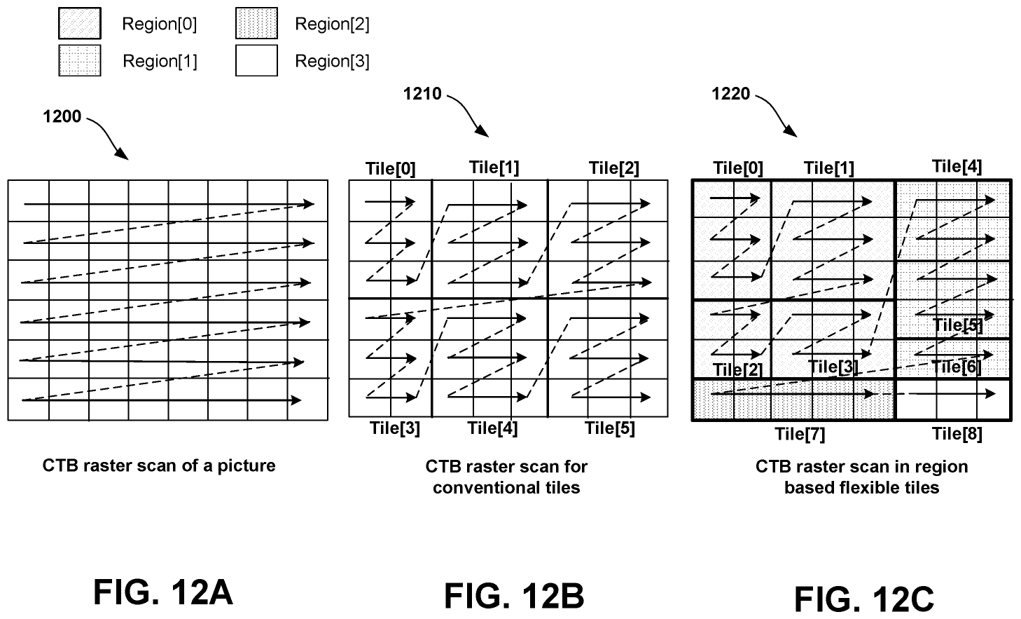

FIG. 12A illustrates an example of a CTB raster scan of a picture frame 1200. FIG. 12B illustrates an example of a CTB raster scan of conventional tiles in a picture frame 1210. FIG. 12C illustrates an example of a CTB raster scan of region-based flexible tiles in a picture frame 1220. The conversion from a CTB address in a CTB raster scan of a picture to a CTB address in conventional tile scan is specified in HEVC [1]. However, HEVC does not specify how to convert from a CTB address in a CTB raster scan of a picture to a CTB address in a region-based flexible tile scan.

In some embodiments, the conversion from a CTB address in a CTB raster scan of a picture to a CTB address in a region-based flexible tile scan may be configured as follows:

1) The variables CtbSizeY, PicWidthInCtbsY, PicHeightInCtbsY are the same as specified in HEVC [1]; and/or 2) using a new list, regionColWidth[i], for i ranging from 0 to num_region_columns_minus1, inclusive, specifying the width of the i-th region column in units of CTBs, and the new list may be derived as follows:

if( uniform_region_flag )

for( i = 0; i <= num_region_columns_minus1; i++ )

regionColWidth[ i ] =(( i + 1)*PicWidthInCtbsY) / (num_region_columns_minus1+1) − (i

* PicWidthInCtbsY ) / (num_region_columns_minus1+1)
else {

regionColWidth[ num_region_columns_minus1 ] = PicWidthInCtbsY
for( i = 0; i < num_region_columns_minus1; i++ ) {

regionColWidth[ i ] = RegionUnitInCtbsY * ( region_column_width_minus1[ i ] +1 )
regionColWidth[ num_region_columns_minus1 ] −= regionColWidth[ i ]

}

}

In some embodiments, a new list regionRowHeight[j] for j ranging from 0 to num_region_rows_minus1, inclusive, specifying the height of the j-th region row in units of CTBs, may be derived as follows:

if( uniform_region_flag )

for( j = 0; j <= num_region_rows_minus1; j++ )

regionRowHeight[ j ] = (( j + 1 ) * PicHeightInCtbsY) / (num_region_rows_minus1 +1) − (j *

PicHeightInCtbsY) / (num_region_rows_minus1 + 1)
else {

regionRowHeight[ num_region_rows_minus1 ] = PicHeightInCtbsY
for( j = 0; j < num_region_rows_minus1; j++ ) {

regionRowHeight[ j ] = RegionUnitInCtbsY * ( region_row_height_minus1[ j ] + 1 )
regionRowHeight[ num_tile_rows_minus1 ] −= regionRowHeight[ j ]

}

}

In some examples, new variables RegionWidthInCtbsY and RegionHeightInCtbsY of i-th region in raster scanning order may be derived as follows:

RegionWidthInCtbsY[i]=regionColWidth[i%(num_region_columns_minus1+1)]

RegionRowInCtbsY[i]=regionRowHeight[i/(num_region_row_minus1+1)]

RegionSizeInCtbsY[i]=RegionWidthInCtbsY[i]*RegionRowInCtbsY[i]

In some embodiments, a new list regionColBd[i] for i ranging from 0 to num_region_columns_minus1+1, inclusive, specifying the location of the i-th region column boundary in units of coding tree blocks, may be derived as follows:

for(regionColBd[0]=0;i=0;i<=num_region_columns_minus1;i++)

regionColBd[i+1]=regionColBd[i]+regionColWidth[i]

In some embodiments, a new list regionRowBd[j] for j ranging from 0 to num_region_rows_minus1+1, inclusive, specifying the location of the j-th region row boundary in units of coding tree blocks, may be derived as follows:

for(regionRowBd[0]=0;j=0;j<=num_region_rows_minus1;j++)

regionRowBd[j+1]=regionRowBd[j]+regionRowHeight[j]

In some embodiments, a new list colWidth[i][j] for j ranging from 0 to num_tile_columns_minus1[i], inclusive, specifying the width of the j-th tile column of i-th region in units of CTBs, may be derived as follows:

if( uniform_spacing_flag )

for( j = 0; j <= num_tile_columns_minus1[ i ]; j++ )

colWidth[i][j] = ((i + 1)*RegionWidthInCtbsY[ i ])/(num_tile_columns_minus1[ i

]+1)−(i*RegionWidthInCtbsY[i]])/ (num_tile_columns_minus1[i]+1)
else {

colWidth[ num_tile_columns_minus1[i] ] = RegionWidthInCtbsY[i]
for( j = 0; j < num_tile_columns_minus1[i]; j++ ) {

colWidth[ i ][ j ] = column_width_minus1[ i ][ j ] + 1
colWidth[ i ][ num_tile_columns_minus1 ] −= colWidth[ i ][ j ]

}

}

In some embodiments, a new list rowHeight[i][j] for j ranging from 0 to num_tile_rows_minus1, inclusive, specifying the height of the j-th tile row of i-th region in units of CTBs, may be derived as follows:

if( uniform_spacing_flag )

for( j = 0; j <= num_tile_rows_minus1[i]; j++ )

rowHeight[i][j] = ((j+1)*RegionHeightInCtbsY[i]) /

(num_tile_rows_minus1[i]+1)−(j*RegionHeightInCtbsY[i]) / (num_tile_rows_minus1[i] +1)
else {

rowHeight[i][ num_tile_rows_minus1[i] ] = RegionHeightInCtbsY[i]
for( j = 0; j < num_tile_rows_minus1[i]; j++ ) {

rowHeight[ i ][ j ] = row_height_minus1[ i ][ j ] + 1
rowHeight[ i ][ num_tile_rows_minus1 ] −= rowHeight[ i ][ j ]

}

}

In some examples, new variables ColumnWidthInLumaSamples[i][j] and RowHeightInLumaSamples[i][j] may be derived as follows:

ColumnWidthInLumaSamples[ i ][ j ] = colWidth[ i ][ j ] * CtbSizeY
RowHeightInLumaSamples[ i ][ j ] = rowHeight[ i ][ j ] * CtbSizeY

In some embodiments, a new list colBd[i][j] forj ranging from 0 to num_tile_columns_minus1 [i]+1, inclusive, specifying the location of the j-th tile column boundary of i-th region in units of coding tree blocks, may be derived as follows:

colBd[i][0] = ( i == 0 ) ? 0 : colBd[ i −1 ][ 0 ] + regionColBd[ i−1 ]
colBd[i][0] = ( colBd[i][ 0 ] == PicWidthInCtbsY ) ? 0 : colBd[i][0]
for ( j = 0; j <= num_tile_columns_minus1[i]; j++ )

colBd[ i ][ j + 1 ] = colBd[i][j] + colWidth[i][j]

In some embodiments, a new list rowBd[i][j] forj ranging from 0 to num_tile_rows_minus1[i]+1, inclusive, specifying the location of the j-th tile row boundary of i-th region in units of coding tree blocks, may be derived as follows:

rowBd[ i ][ 0 ] = ( i == 0 ) ? 0 : rowBd[ i −1 ][ 0 ] + regionRowBd[ i−1 ]
rowBd[ i ][ 0 ] = (rowBd[ i ][ 0 ] == PicHeightInCtbsY) ? 0 : rowBd[ i ][ 0 ]
for( j = 0; j <= num_tile_rows_minus1[ i ]; j++ )

rowBd[ i ][ j + 1 ] = rowBd[ i ][ j ] + rowHeight[ i ][ j ]

In some embodiments, a list CtbAddrRsToTs[ctbAddrRs] for ctbAddrRs ranging from 0 to PicSizeInCtbsY−1, inclusive, specifying the conversion from a CTB address in CTB raster scan of a picture to a CTB address in region-based tile scan, may be derived as follows:

for ( ctbAddrRs = 0; ctbAddrRs < PicSizeInCtbsY; ctbAddrRs++ ) {

tbX = ctbAddrRs % PicWidthInCtbsY
tbY = ctbAddrRs / PicWidthInCtbsY
for( i = 0; i <= num_region_columns_minus1; i++ )

if ( tbX >= regionColBd[ i ])

regionX = i

for ( j = 0; j <= num_region_rows_minus1; j++ )

if( tbY >= regionRowBd[ j ] )

regionY = j

regionId = regionY * ( num_region_columns_minus1 +1 ) + regionX
for ( i = 0; i <= num_tile_columns_minus1[ regionId ]; i++ )

if( tbX >= colBd[ regionId][ i ] )

tileX = i

for( j = 0; j <= num_tile_rows_minus1[ regionId ]; j++ )

if( tbY >= rowBd[ regionId ][ j ] )

tileY = j

CtbAddrRsToTs[ ctbAddrRs ] = 0
for (i = 0; i < regionId; i++)

CtbAddrRsToTs[ ctbAddrRs ] += RegionSizeInCtbsY[ i ]

for( i = 0; i < tileX; i++ )

CtbAddrRsToTs[ ctbAddrRs ] += rowHeight[ regionId ][ tileY ] * colWidth[ regionId ][ i ]

for( j = 0; j < tileY; j++ )

CtbAddrRsToTs[ ctbAddrRs ] += RegionWidthInCtbsY[ regionId ] * rowHeight] regionId ][ j ]

CtbAddrRsToTs[ ctbAddrRs ] += ( tbY − rowBd[ regionId ][ tileY ] ) * colWidth[ regionId ][ tileX ] + tbX −

colBd[ regionId ][ tileX ]
}

A list CtbAddrTsToRs[ctbAddrTs] for ctbAddrTs ranging from 0 to PicSizeInCtbsY−1, inclusive, specifying the conversion from a CTB address in region-based tile scan to a CTB address in CTB raster scan of a picture, may be derived as follows:

for( ctbAddrRs = 0; ctbAddrRs < PicSizeInCtbsY; ctbAddrRs++ )

CtbAddrTsToRs[ CtbAddrRsToTs[ ctbAddrRs ] ] = ctbAddrRs2

A list TileId[ctbAddrTs] for ctbAddrTs ranging from 0 to PicSizeInCtbsY−1, inclusive, specifying the conversion from a CTB address in tile scan to a tile index or ID, may be derived as follows:

for ( n = 0, tileIdx = 0, regionIdx = 0; n <= num_region_rows_minus1; n++ )

for( m = 0; m <= num_region_columns_minus1; m++, regionIdx ++)
for( j = 0, j <= num_tile_rows_minus1[ regionIdx ]; j++ )

for( i = 0; i <= num_tile_columns_minus1[ regionIdx]; i++, tileIdx++ )

for( y = rowBd[regionIdx][ j ]; y < rowBd[regionIdx][ j + 1 ]; y++ )

for( x = colBd[regionIdx][ i ]; x < colBd[regionIdx][ i + 1 ]; x++ )

TileId[ CtbAddrRsToTs[ y * PicWidthInCtbsY+ x ] ] = tileIdx

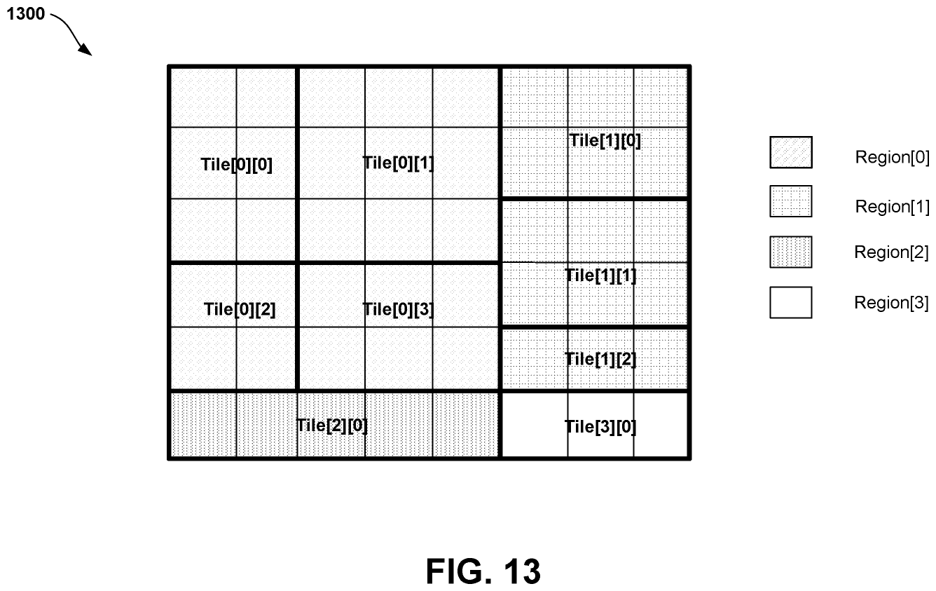

In an alternate embodiment, the tile identifier (ID) for each region-based tile may be represented by a two-dimensional (2D) array. The first index may be the region index and the second index may be the tile index in the region. FIG. 13 is an example of TileID representation in a picture frame 1300.

The conversion from a CTB address in tile scan to a 2D tile ID, TileId0[ctbAddrTs] and TileId1[ctbAddrTs] (e.g., two new lists), for ctbAddrTs ranging from 0 to PicSizeInCtbsY−1, inclusive, may be derived as follows:

for ( n = 0, regionIdx = 0; n <= num_region_rows_minus1; n++ ) {

for( m = 0; m <= num_tile_columns_minus1; m++; regionIdx++) {

TileId0[ CtbAddrRsToTs[ y * PicWidthInCtbsY+ x ] ] = regionIdx
for( j = 0, tileIdx = 0; j <= num_tile_rows_minus1[ regionIdx ]; j++ )

for( i = 0; i <= num_tile_columns_minus1[ regionIdx ]; i++, tileIdx++ )

for( y = rowBd[regionIdx][ j ]; y < rowBd[regionIdx][ j + 1 ]; y++ )

for( x = colBd[[regionIdx][ i ]; x < colBd[regionIdx][ i + 1 ]; x++ )

TileId1[ CtbAddrRsToTs[ y * PicWidthInCtbsY+ x ] ] = tileIdx

}

}

V.5 Initial Quantization Parameter for Tile Coding

In some embodiments, HEVC may specify an initial quantization value for each slice. One or more initial quantization parameters (QP) may be used for the coding blocks in the slice. The initial value of the luma quantization parameter for the slice, SliceQp_{Y}, is derived as follows:

SliceQp_{Y}=26+init_qp_minus26+slice_qp_delta

wherein init_qp_minus26 is signaled in the PPS, and slice_qp_delta is signaled in the independent slice segment header.

The chroma quantization parameters for the slice and the coding blocks in the slice are signaled in the PPS and the slice header as well.

For omnidirectional video processing, a set of tiles may map to a viewport or face. Each viewport or face may be coded into a different quality (e.g., resolution) to support viewport-dependent video processing. The quantization parameter of the tile may be inferred from the slice header, SliceQp_{Y}, as specified in HEVC, or may be explicitly signaled as a property of the tile.

In some examples, signaling of 360-degree video information [6] may be used. For example. the QP for each face may be explicitly signaled in case a particular face is encoded at a higher or lower quality than another face. The coding tree blocks belonging to the same face may share the same initial QP signals for the face.

In some embodiments, the QP may be signaled at the region and/or tile level so that all the tiles belonging to the same region may share the same initial regional QP. Alternately, each tile may have its own initial QP value based on an initial regional QP and a QP offset value of an individual tile. Table 4 shows an exemplary signaling structure in accordance with such an embodiment.

TABLE 4
QP Signaling for Region-based Flexible Tile

Descriptor

qp_format( ) {

| | |
|---|---|
| region_qp_offset_enabled_flag | u(1) |
| if (region_qp_offset_enabled_flag) | |

for (i = 0; i < NumRegions; i++ ) {

| | |
|---|---|
| region_qp_offset[ i ] | se(v) |
| tile_qp_offset_enable_flag | u(1) |
| if (tile_qp_offset_enable_flag) { | |

for ( m = 0; m < num_tile_rows_minus1 [i]; m++ )

for ( n = 0; n < num_tile_columns_minus1[i]; n++ )

| | |
|---|---|
| tile_qp_offset [ i ][ m ][ n ] | se(v) |

}

}

}

region_qp_offset_enabled_flag specifies whether different QPs are used for different region(s).

region_qp_offset[i] specifies the initial value of QP to be used for the tiles in the region until modified by the value of tile_qp_offset in the coding unit layer. The initial value of the Qp_{Y} quantization parameter for the i-th region, RegionQp_{Y}[i], may be derived as follows:

RegionQp_{Y}[i]=26+init_qp_minus26+region_qp_delta[i]

tile_qp_offset_enabled_flag specifies whether different QPs are used for the different tiles.

tile_qp_offset[i][m][n] specifies the initial value of QP to be used for the coding blocks in the tile at position [m][n] of the i-th region. When not present, the value of tile_qp_offset can be inferred to be equal to 0. The value of the quantization parameter, TileQpY[i][m][n], may be derived as follows:

TileQp_{Y}[i][m][n]=RegionQp_{Y}[i]+tile_qp_delta[i][m][n]

The QP of each tile may be specified in the order of the tile index. The tile index may be derived from the region index and the value of tile column and row as follows:

for ( tileIdx = 0, i = 0; i < NumRegions; i++ )

for ( m = 0; m <= num_tile_rows_minus1[i]; m++)

for ( n = 0; n <= num_tile_cols_minus1[i]; n++, tileIdx++)

TileQpY[tileIdx] = RegionQpY[ i ] + tile_qp_delta[ i ][ m ][ n ]

In an alternate embodiment, the tile QP offset may be specified in a list, and each tile may derive its initial QP value by referring to the corresponding table index. Table 5 shows an exemplary QP offset list and Table 6 shows an exemplary tile QP format.

TABLE 5
QP Table

Descriptor

qp_offset_table( ) {

| | |
|---|---|
| tile_qp_offset_list_len_minus1 | ue(v) |
| for (i = 0; i < num_qp_candidates; i++ ) { | |

| | |
|---|---|
| tile_qp_offset_list[ i ] | se(v) |

}

}

tile_qp_offset_list_len_minus1 plus 1 specifies the number of tile_qp_offset_list syntax elements. tile_qp_offset_list specifies a list of QP offset value(s) used in the derivation of the tile QP from the initial QP.

TABLE 6
Tile Initial QP Signaling

Descriptor

tile_qp_format( ) {

for ( i = 0; i < total_num_tiles; i++ ) {

| | |
|---|---|
| tile_qp_offset_idx[ i ] | u(8) |

}

}

tile_qp_offset_idx specifies the index into the tile_qp_offset_list that is used to determine the value of TileQpOffset_{Y}. When present, the value of tile_qp_offset_idx shall be in the range of 0 to tile_qp_offset_list_len_minus1, inclusive.

In some embodiments, the variables, TileQpOffset_{Y}[i] and TileQp_{Y}[i], of i-th tile may be derived as follows:

TileQpOffsetY[i] = tile_qp_offset_list[ tile_qp_offset_idx ]

TileQpY[i] = 26 + init_qp_minus26 + TileQpOffsetY[i]

Each of the following references is incorporated by reference herein: [1] JCTVC-R1013_v6, “Draft high efficiency video coding (HEVC) version2,” June 2014; [2] ISO/IEC JTC1/SC29/WNG11 N17827 “WD2 of ISO/IEC 23090-2 OMAF 2^{nd} edition”, July. 2018; [3] JVET-K0155, “AHG12: Flexible Tile Partitioning”, July 2018; [4] JVET-K0260, “Flexible tile”, July 2018; [5] JVET-D0075, “AHG8: Geometry padding for 360 video coding”, October 2016; [6] PCT Patent Application Publication No. WO2018/045108; [7] U.S. Patent Application No. 62/775,130; and [8] U.S. Patent Application No. 62/781,749.

### VII. Conclusion

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (e.g., but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of (or interchangeable with) any UE or mobile device recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1-11. (canceled)

12. A method for processing video information, comprising:
receiving a padding flag indicating whether a padding operation is to be performed on one or more grid region edges of a respective grid region in a frame; and
performing the padding operation on the one or more grid region edges in the frame based on the received padding flag.

13. The method of claim 12, wherein the padding operation comprises a repetitive padding or a geometry padding.

14. The method of claim 12, wherein the padding flag is received in any of: a padding and loop filter syntax, a parameter set, or a slice header.

15. The method of claim 12, further comprising:
receiving a set of first parameters that defines a plurality of first grid regions comprising the frame;
for each first grid region, receiving a set of second parameters that defines a plurality of second grid regions, wherein the plurality of second grid regions partitions the respective first grid region;
partitioning the frame into the plurality of first grid regions based on the set of first parameters; and
partitioning each first grid region into the plurality of second grid regions based on the respective set of second parameters.

16. The method of claim 15, wherein the set of first parameters and the sets of second parameters are received in any of: a sequence parameter set, a picture parameter set, or a slice header.

17-20. (canceled)

21. The method of claim 12, wherein the padding flag indicates whether a horizontal wrap-around motion compensation is enabled or disabled, wherein the padding operation comprises the horizontal wrap-around motion compensation.

22. The method of claim 12, wherein the padding flag indicates that a vertical wrap-around motion compensation is enabled or disabled, wherein the padding operation comprises the vertical wrap-around motion compensation.

23. The method of claim 12, further comprising:
receiving a set of first parameters that defines a plurality of first grid regions;
receiving a set of second parameters that defines a plurality of second grid regions;
partitioning the frame into the plurality of first grid regions based on the set of first parameters; and
grouping the plurality of first grid regions into the plurality of second grid regions based on the set of second parameters.

24. The method of claim 23, wherein each first grid region or each second grid region is different in size.

25. A method for processing video information, comprising:
determining whether a padding operation is to be performed on one or more grid region edges of a respective grid region in a frame; and
sending a padding flag to indicate whether the padding operation is to be performed on the one or more grid region edges in the frame.

26. The method of claim 25, wherein the padding operation comprises a repetitive padding or a geometry padding.

27. The method of claim 25, wherein the padding flag is sent in any of: a padding and loop filter syntax, a parameter set, or a slice header.

28. The method of claim 25, wherein the padding flag indicates whether a horizontal wrap-around motion compensation is enabled or disabled, wherein the padding operation comprises the horizontal wrap-around motion compensation.

29. The method of claim 25, further comprising:
determining a set of first parameters that defines a plurality of first grid regions comprising the frame;
for each first grid region, determining a set of second parameters that defines a plurality of second grid regions, wherein the plurality of second grid regions partitions the respective first grid region; and
sending, for partitioning the frame, information indicating the set of first parameters and the sets of second parameters.

30. An apparatus comprising:
one or more processors configured to:
determine whether a padding operation is to be performed on one or more grid region edges of a respective grid region in a frame; and
generate a padding flag to indicate whether the padding operation is to be performed on the one or more grid region edges in the frame; and
a transmitter configured to send a message including the padding flag.

31. The apparatus of claim 30, wherein the transmitter is configured to send the padding flag in any of: a padding and loop filter syntax, a parameter set, or a slice header.

32. The apparatus of claim 30, wherein the padding flag indicates whether a horizontal wrap-around motion compensation is enabled or disabled, wherein the padding operation comprises the horizontal wrap-around motion compensation.

33. An apparatus comprising:
a receiver configured to receive a padding flag indicating whether a padding operation is to be performed on one or more grid region edges of a respective grid region in a frame; and
one or more processors configured to perform the padding operation on the one or more grid region edges in the frame based on the received padding flag.

34. The apparatus of claim 33, wherein the padding operation comprises a repetitive padding or a geometry padding.

35. The apparatus of claim 33, wherein the padding flag indicates whether a horizontal wrap-around motion compensation is enabled or disabled, wherein the padding operation comprises the horizontal wrap-around motion compensation.
